(19) United States
(12) Patent Application Publication
(10) Pub. No.: US 2009/0218979 A1
(43) Pub. Date: Sep. 3, 2009

(54) OPTICAL HEAD MOVING CONTROL APPARATUS AND OPTICAL HEAD MOVING CONTROL METHOD

(75) Inventors: Hideo YAMASAKI, Tokyo (JP); Masanori KOSAKI, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/395,150

(22) Filed: Feb. 27, 2009

(30) Foreign Application Priority Data
Feb. 29, 2008 (JP) 2008-050573

(51) Int. Cl. G05B 15/02

(52) U.S. Cl. 318/600

(57) ABSTRACT

According to one embodiment, an optical head moving control apparatus according to one embodiment of the invention includes a stepping motor configured to be rotationally driven by a two-phase excitation scheme to move an optical head in a first direction and in a second direction opposite to the first direction, and a motor driver configured to control stop and resumption of rotational driving of the stepping motor at a plurality of electrical angles different from a plurality of electrical angles corresponding to a plurality of two-phase excitation points at which the absolute values of driving voltages of two phases supplied to the stepping motor are equal.

### CROSS-REFERENCE TO RELATED APPLICATIONS

This application is based upon and claims the benefit of priority from Japanese Patent Application No. 2008-050573, filed Feb. 29, 2008, the entire contents of which are incorporated herein by reference.

### BACKGROUND

1. Field

One embodiment of the invention relates to an optical head moving control method and optical head moving control apparatus for controlling driving of a stepping motor which is rotationally driven by a two-phase excitation scheme and causing the stepping motor to control movement of an optical head.

2. Description of the Related Art

An optical disk drive has an optical pickup head (PUH) for recording information on an optical disk or playing back information recorded on an optical disk. The optical pickup head moves along the radial direction of the optical disk as, e.g., a stepping motor is rotationally driven. The recent development of the optical disk technology is remarkable, and various proposals have been made in association with moving control of the optical pickup head.

For example, a focus servo is set, and in this state, a predetermined driving waveform is input to the stepping motor to move the optical pickup head by one microstep (μstep). A track cross signal obtained from the output of the optical pickup head at this time is counted. The moving amount of the optical pickup head corresponding to the predetermined driving waveform is thus obtained and stored. Jpn. Pat. Appln. KOKAI Publication No. 2003-187471 discloses a technique of correcting the driving waveform based on moving amount information at the time of playback or recording of an optical disk.

As is known, however, an electrical angle at which the position accuracy becomes unstable is present in the microstep driving of the stepping motor. The above-described technique can hardly improve the degradation in the positioning accuracy caused by the unstable electrical angle.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic view of an optical disk device to which an optical head moving control apparatus according to an embodiment of the invention is applied;

FIG. 2 is a view showing the schematic arrangement of the feeding mechanism of an optical pickup head in the optical disk device shown in FIG. 1;

FIG. 3A is a graph showing the waveforms of voltages of two phases (phases A and B) necessary for microstep rotational driving of a stepping motor according to the embodiment;

FIG. 3B is a graph showing the relationship between the driving signal phase (electrical angle) of phases A and B and the lead shaft rotation angle (upon independent driving of the motor) according to the embodiment;

FIG. 3C is a graph showing the relationship between the driving signal phase (electrical angle) and the position of the optical pickup head according to the embodiment;

FIG. 4A is a graph showing the waveforms of voltages of two phases (phases A and B) necessary for microstep rotational driving of a stepping motor according to the embodiment;

FIG. 4B is a graph showing the relationship between the driving signal phases (electrical angles) of phases A and B according to the embodiment;

FIG. 4C is a graph showing the relationship between the electrical angle and the moving amount of the optical pickup head (the moving amount of one microstep) which is fed in the microstep driving mode (sin, cos driving) according to the embodiment;

FIG. 4D is a graph showing a microstep moving amount (actual measurement value) in a forward (FWD) operation according to the embodiment;

FIG. 4E is a graph showing a microstep moving amount (actual measurement value) in a backward (BWD) operation according to the embodiment;

FIG. 5A is a graph showing a microstep driving waveform in a forward (FWD) operation according to another embodiment;

FIG. 5B is a graph showing a microstep driving waveform in a forward (FWD) operation according to another embodiment;

FIG. 5C is a graph showing an effect obtained by applying the microstep driving waveform shown in FIGS. 5A and 5B according to another embodiment;

FIG. 6A is a graph showing a microstep driving waveform in a backward (BWD) operation according to another embodiment;

FIG. 6B is a graph showing a microstep driving waveform in a backward (BWD) operation according to another embodiment;

FIG. 6C is a graph showing an effect obtained by applying the microstep driving waveform shown in FIGS. 6A and 6B according to another embodiment;

FIG. 7A is a graph showing an example of a microstep driving waveform when the driving voltage is lowered;

FIG. 7B is a graph showing an example of a microstep driving waveform corresponding to a low voltage; and

FIG. 7C is a graph showing an effect obtained by applying the microstep driving waveform shown in FIGS. 7A and 7B.

### DETAILED DESCRIPTION

Various embodiments according to the invention will be described hereinafter with reference to the accompanying drawings. In general, an optical head moving control apparatus according to one embodiment of the invention comprises a stepping motor configured to be rotationally driven by a two-phase excitation scheme to move an optical head in a first direction and in a second direction opposite to the first direction, and a motor driver configured to control stop and resumption of rotational driving of the stepping motor at a plurality of electrical angles different from a plurality of electrical angles corresponding to a plurality of two-phase excitation points at which absolute values of driving voltages of two phases supplied to the stepping motor are equal.

An embodiment of the invention will now be described with reference to the accompanying drawing.

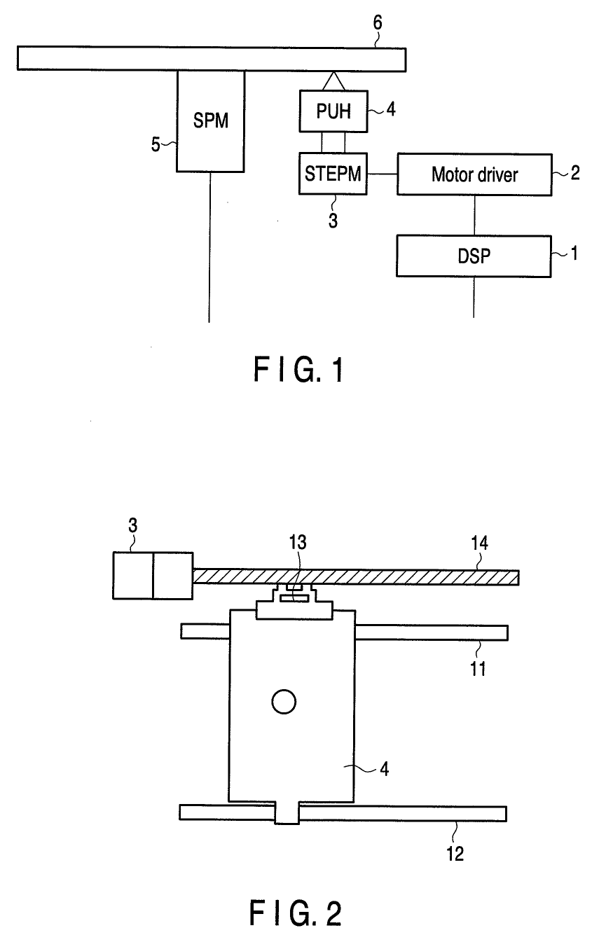

FIG. 1 is a view showing the schematic arrangement of an optical disk device to which an optical head moving control apparatus according to an embodiment of the invention is applied. The optical head moving control apparatus includes a DSP (Digital Signal Processor) 1, stepping motor driver 2, and stepping motor 3.

The DSP 1 supplies a driving signal to the stepping motor driver 2. The stepping motor driver 2 applies driving voltages of two phases (phases A and B) to the stepping motor 3 based on the driving signal from the DSP 1. That is, the stepping motor driver 2 controls driving of the stepping motor. The stepping motor 3 is rotationally driven by a two-phase excitation scheme, i.e., based on driving voltages of two phases (phases A and B) applied from the stepping motor driver 2. The rotational driving of the stepping motor 3 is converted into back and forth movements along the radial direction of an optical disk 6. Hence, an optical pickup head 4 moves along the radial direction of the optical disk 6. The optical disk 6 is rotated by a spindle motor 5.

FIG. 2 is a view showing the schematic arrangement of the feeding mechanism of the optical pickup head 4 in the optical disk device. The optical pickup head 4 moves upon receiving a driving force in the inner and outer circumferential directions from a rack 13 while being guided by a main shaft 11 and a sub-shaft 12. The rack 13 is jointed to the optical pickup head 4. The teeth at the distal end of the rack 13 engage with a lead shaft 14. Hence, the rack 13 can move in the inner and outer circumferential directions as the lead shaft 14 rotates. The lead shaft 14 is integrated with the output shaft of the stepping motor 3 or engaged with the output shaft via a power transmission means.

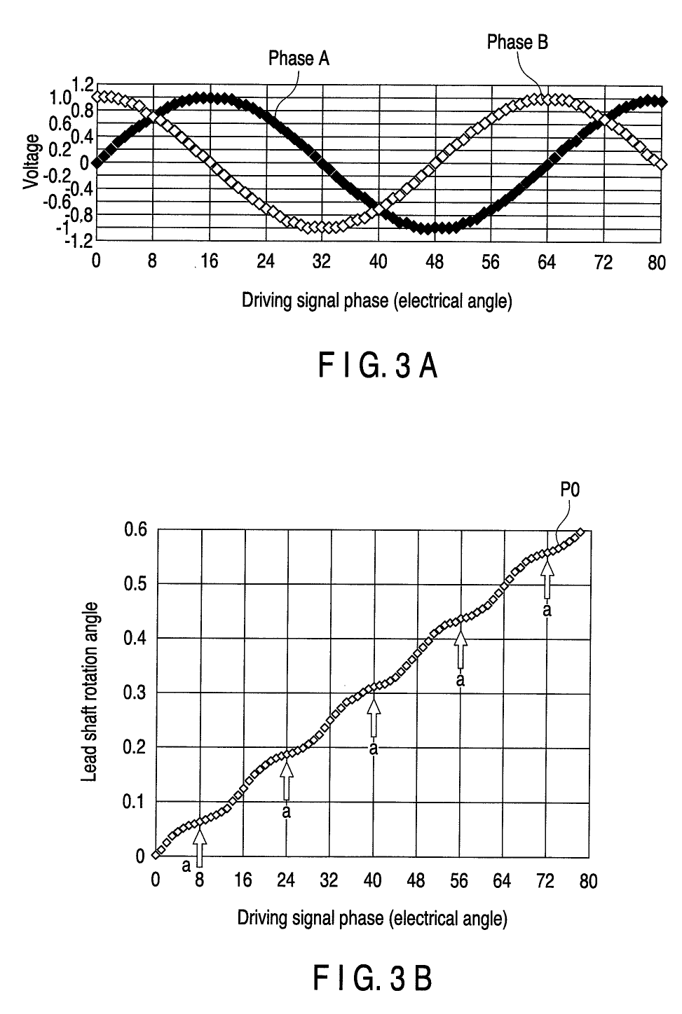

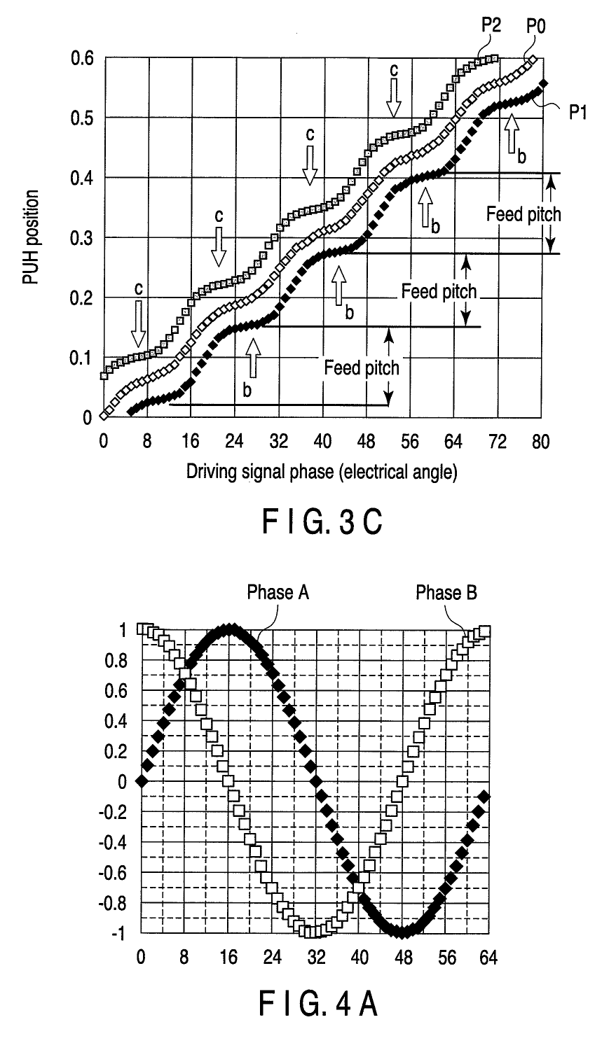

The stepping motor 3 includes driving coils of two phases (phases A and B). To increase the resolving power of feed accuracy, microstep driving is used. FIG. 3A is a graph showing the waveforms of voltages of two phases (phases A and B) necessary for microstep rotational driving of the stepping motor 3. The phases A and B generate magnetic fields with a phase shift of 90° in the motor. As the magnetic fields change, the output shaft (lead shaft 14) integrated with a permanent magnet rotates.

FIG. 3B is a graph showing the relationship between the driving signal phases (to be referred to as electrical angles) of the phases A and B and the lead shaft rotation angle (upon independent driving of the motor). As described above, the rotation angle stabilizes at a point (two-phase excitation point) where the absolute values of the voltages of the phases A and B are equal. The rotation angle tends to be unstable at an intermediate point between two-phase excitation points, i.e., at a point (one-phase excitation point) where one of the voltages of the phases A and B is zero. This occurs due to the electromagnetic characteristic in the stepping motor 3. The two-phase excitation point electromagnetically has a high neutral stability. Arrows a in FIG. 3B indicate two-phase excitation points (electrical angles of 8, 24, 40, 56, 72, . . . ) A plot P0 indicates the lead shaft rotation angle upon an independent operation of the stepping motor 3.

FIG. 3C is a graph showing the relationship between the driving signal phase (electrical angle) and the position of the optical pickup head 4. A plot P1 in FIG. 3C indicates the electrical angle and the position of the optical pickup head 4 when it is moved in the forward (FWD) direction. A plot P2 indicates the electrical angle and the position of the optical pickup head 4 when it is moved in the backward (BWD) direction reverse to the forward direction. The plot P2 exhibits a behavior having a delay with respect to the lead shaft rotation upon an independent operation of the stepping motor 3. As is apparent from the comparison between FIGS. 3B and 3C, the linearity accuracy with respect to the electrical angle degrades, and a shift (phase shift) occurs in the electrical angle at which the position of the optical pickup head 4 stabilizes.

When the frictional load of the optical pickup head 4 is applied, and more specifically, when the frictional force between the rack 13 and the lead shaft 14 or between the optical pickup head 4 and the main shaft 11 and sub-shaft 12 increases, the rotating force of the stepping motor 3 is accumulated as the distortion of the elastic deformation of the rack 13. Consequently, the following phenomena conspicuously occur. That is, even when the electrical angle of the stepping motor 3 changes, no displacement of the optical pickup head 4 occurs, or when a driving force more than the balance between the frictional force and the elastic deformation of the rack 13 is applied, the optical pickup head 4 moves at a time. Generally, the output shaft of the stepping motor 3 tends to rotate at a time at a one-phase excitation point. However, the influence of the elastic deformation or friction of the rack 13 appears even near a two-phase excitation point. This is the reason why the position of the optical pickup head 4 cannot fix when it is stopped or started at a two-phase excitation point by microstep driving.

For example, when a label is printed on the optical disk 6, position feedback obtained from the optical disk 6 is not used. Hence, the print quality of the label may be poorer because of the unreliable positioning of the optical pickup head 4 caused by the above-described reason.

To prevent this, in the stepping motor driving scheme of the first embodiment, a stop point in the FWD operation is set at a point indicated by an arrow b, i.e., a point having a phase lead from a two-phase excitation point by a predetermined electrical angle. More specifically, the stepping motor driver 2 stops the stepping motor 3 at an electrical angle advanced from a two-phase excitation point in the moving direction (the direction corresponding to the increase in the electrical angle) by a predetermined number of microsteps, thereby ensuring the stop position accuracy.

For example, the driving waveform is divided into 64 parts. In microstep driving, the two-phase excitation points are defined at electrical angles of 8, 24, 40, 56, and 72. In this case, the stepping motor 3 is stopped at an electrical angle after passing through a two-phase excitation point. As shown in FIG. 3C, stop/rotation of the stepping motor 3 is repeated at phases advanced by four microsteps in terms of electrical angle, i.e., at electrical angles of 12, 28, 44, 60, 76, . . . , thereby ensuring the feed pitch accuracy. Alternatively, stop/rotation of the stepping motor 3 is repeated at phases advanced by two microsteps in terms of electrical angle, i.e., at electrical angles of 10, 26, 42, 58, 74, . . . , thereby ensuring the feed pitch accuracy. If the stepping motor 3 is stopped every 32 microsteps, stop/movement of the stepping motor 3 is repeated at electrical angles of, e.g., 10, 42, 74, 106, . . . , thereby ensuring the feed pitch accuracy.

As in the FWD operation, a stop point in the BWD operation is set at a point indicated by an arrow c, i.e., a point having a phase lead from a two-phase excitation point by a predetermined electrical angle. In this case as well, the stepping motor driver 2 stops the stepping motor 3 at an electrical angle advanced from a two-phase excitation point in the moving direction (the direction corresponding to the decrease in the electrical angle) by a predetermined number of microsteps, thereby ensuring the stop position accuracy.

For example, the driving waveform is divided into 64 parts. In microstep driving, the two-phase excitation points are defined at electrical angles of 8, 24, 40, 56, and 72. In this case, the stepping motor 3 is stopped at an electrical angle after passing through a two-phase excitation point. As shown in FIG. 3C, stop/rotation of the stepping motor 3 is repeated at phases advanced by four microsteps in terms of electrical angle, i.e., at electrical angles of 4, 20, 36, 52, 68, . . . , thereby ensuring the feed pitch accuracy. Alternatively, stop/rotation of the stepping motor 3 is repeated at phases advanced by two microsteps in terms of electrical angle, i.e., at electrical angles of 6, 22, 38, 54, 70, . . . , thereby ensuring the feed pitch accuracy.

As described above, the displacement of the position of the optical pickup head 4 tends to stabilize at an advanced electrical angle because of, e.g., the friction at the contact between the rack and the lead shaft of the stepping motor 3, the elastic deformation factor, and the friction factor between the main shaft and the optical pickup head 4. For this reason, the stepping motor driving scheme of the first embodiment can improve the stop position accuracy. More specifically, stop/rotation of the stepping motor 3 is repeated at each point where it stabilizes (the change from the adjacent step is small), i.e., at each point where the feed pitch accuracy can be ensured, thereby ensuring the stop position pitch accuracy.

The above-described method allows to stop the optical pickup head 4 at an electrical angle where the position accuracy stabilizes. That is, the stepping motor 3 is not stopped at an unstable electrical angle, thereby improving the position accuracy of the optical pickup head 4 and increasing the quality of, e.g., label printing on the optical disk.

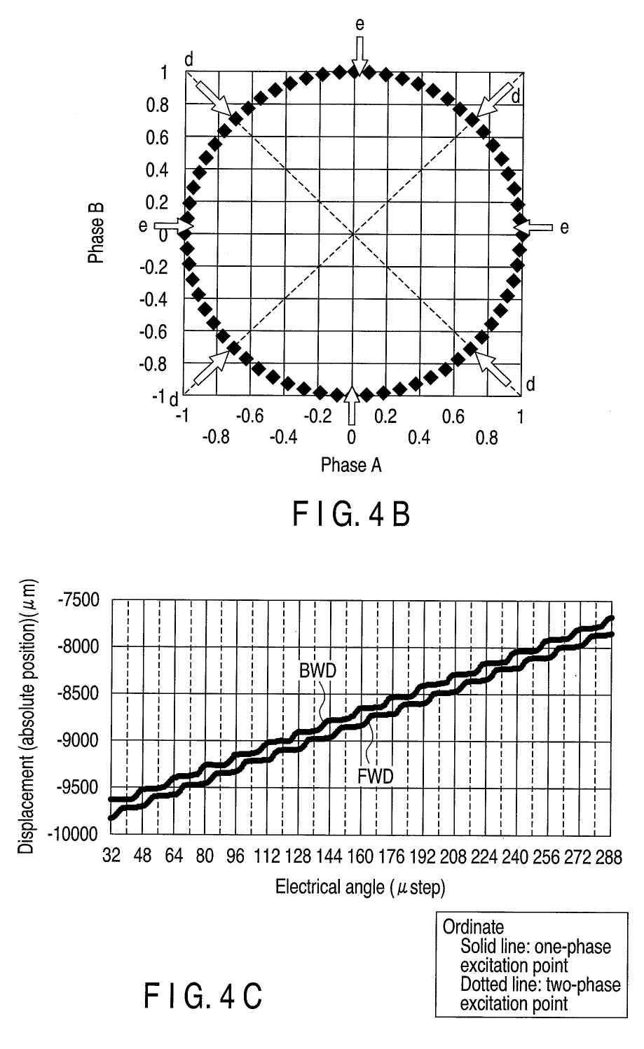

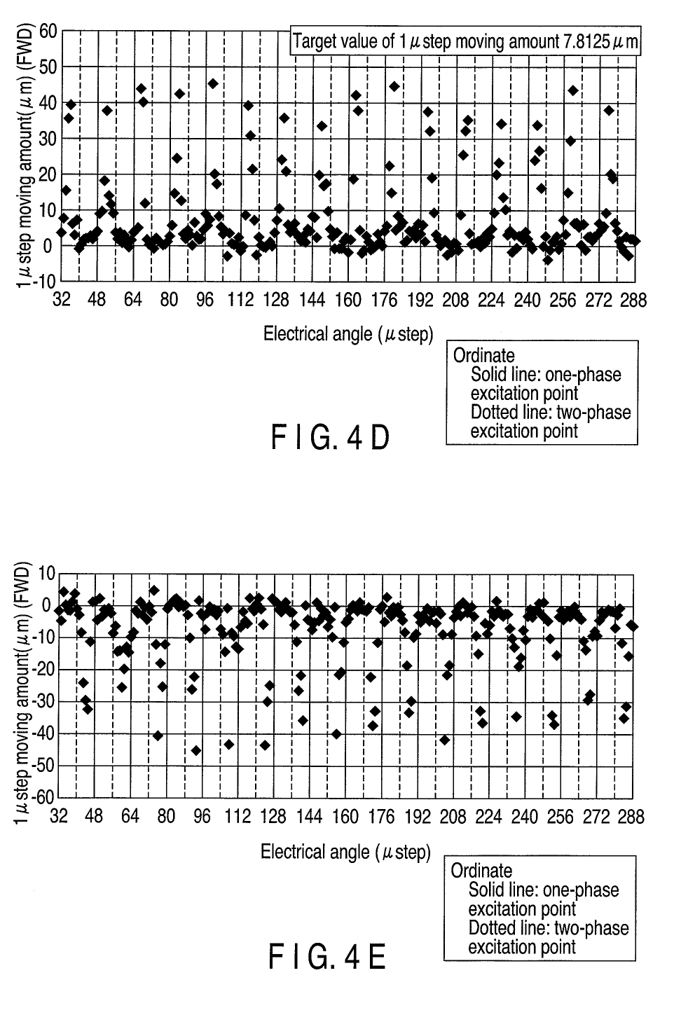

FIG. 4A is a graph showing the waveforms of voltages of two phases (phases A and B) necessary for microstep rotational driving of the stepping motor 3. FIG. 4B is a graph showing the relationship between the driving signal phases (to be referred to as electrical angles) of the phases A and B. The rotation angle stabilizes at a point (to be referred to as a two-phase excitation point) where the absolute values of the voltages of the phases A and B are equal. The rotation angle is unstable at a point (to be referred to as a one-phase excitation point) where one of the voltages of the phases A and B is zero. As shown in FIG. 4B, an arrow d indicates a two-phase excitation point, and an arrow e indicates a one-phase excitation point.

FIG. 4C is a graph showing the relationship between the electrical angle and the moving amount of the optical pickup head 4 (the moving amount of one microstep) which is fed in the microstep driving mode (sin, cos driving). As is apparent from FIG. 4C, an electrical angle at which the moving amount of one microstep increases exists on a way from a one-phase excitation point to a two-phase excitation point. More specifically, as shown in FIGS. 4D and 4E, a phenomenon that the moving amount of one microstep increases to about 45 μm occurs every 16 microsteps. The difference from the moving amount (target value ±7.8125 μm) of the optical pickup head which is assumed to move uniformly in each microstep is large. That is, the optical pickup head 4 is not smoothly fed.

The objective lens on the optical pickup head 4 follows the optical disk as the track servo is turned on. Hence, if the optical pickup head 4 moves largely, the shift of the objective lens instantaneously becomes large, degrading the optical performance.

A stepping motor driving scheme of the second embodiment to be described here can solve this problem. The stepping motor driving scheme of the second embodiment controls the driving waveform to make the moving amount of one microstep closer to the target value within the range (n) of a finite number of microstep divisions.

More specifically, the microstep division is made fine near an electrical angle at which the moving amount of one microstep is large, and coarse near an electrical angle at which the moving amount of one microstep is small. For example, the microstep division is made fine at an electrical angle (phase) near a one-phase excitation point between a two-phase excitation point and the next two-phase excitation point, and coarse at an electrical angle (phase) near a two-phase excitation point. That is, within the range of a plurality of electrical angles including a plurality of electrical angles corresponding to a plurality of two-phase excitation points (i.e., near a two-phase excitation point), the rotational driving of the stepping motor 3 is controlled based on a electrical angles corresponding to a (n>a) microsteps divided at a first interval that is relatively coarse. Within the range of a plurality of electrical angles including a plurality of electrical angles corresponding to a plurality of one-phase excitation points (i.e., near a one-phase excitation point), the rotational driving of the stepping motor 3 is controlled based on b electrical angles corresponding to b (n>b>a, n≧a+b) microsteps divided at a second interval that is relatively fine. This allows to reduce the unevenness of the moving amount of one microstep and smoothly move the optical pickup head 4.

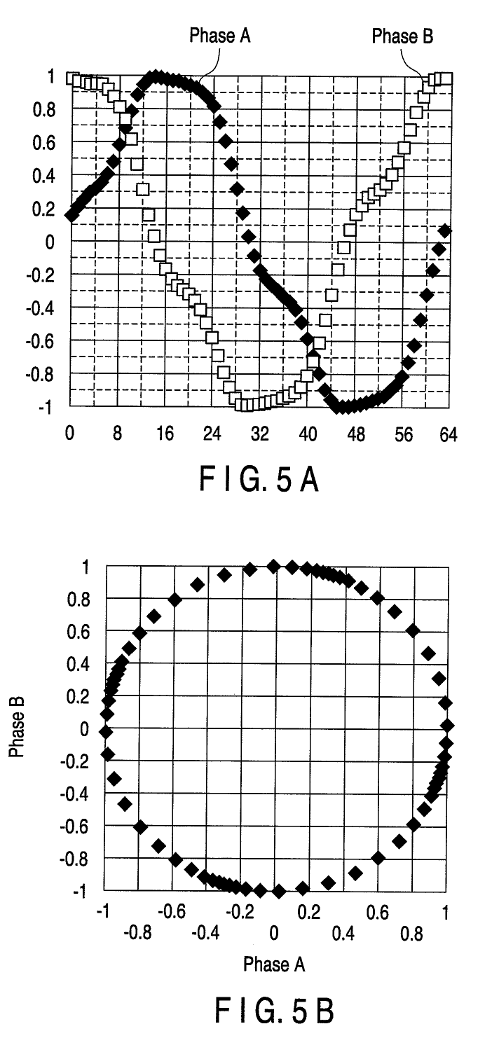

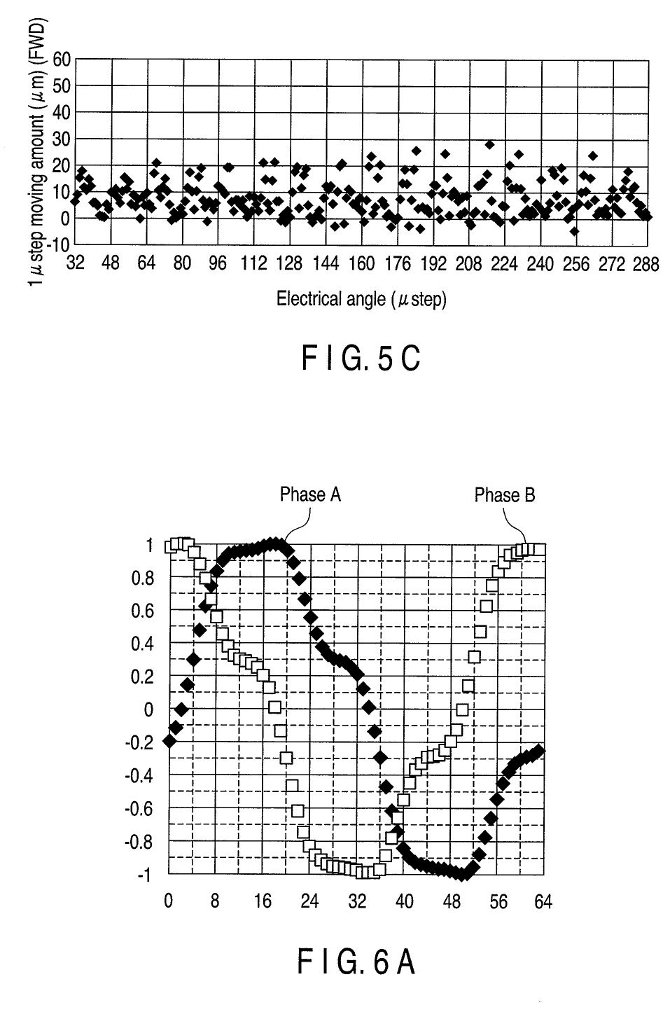

More specifically, the microstep division is appropriately controlled when moving the optical pickup head 4 in the forward (FWD) direction or in the backward (BWD) direction. When feeding the optical pickup head 4 in the forward (FWD) direction, the number of microstep divisions is increased near a predetermined electrical angle (phase) after passing through a one-phase excitation point in the forward direction. More specifically, when moving the optical pickup head 4 in the FWD direction corresponding to the increase in the electrical angle, the rotational driving of the stepping motor 3 is controlled based on the b electrical angles corresponding to the b microsteps divided at the second interval within the range of a plurality of electrical angles equal to or larger than a plurality of electrical angles corresponding to a plurality of one-phase excitation points (i.e., near a predetermined electrical angle after passing through a one-phase excitation point in the FWD direction). FIGS. 5A and 5B show detailed driving waveforms. This makes the moving amount of one microstep closer to the target value of 7.8125 μm, as shown in FIG. 5C.

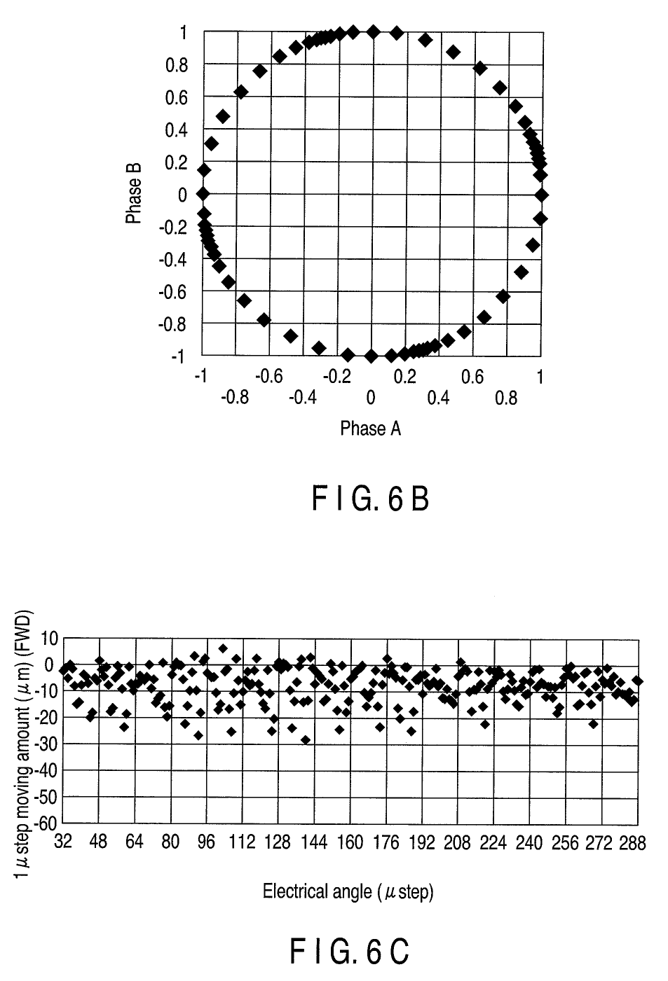

When feeding the optical pickup head 4 in the backward (BWD) direction, the number of microstep divisions is increased near a predetermined electrical angle (phase) after passing through a one-phase excitation point in the backward direction. More specifically, when moving the optical pickup head 4 in the BWD direction corresponding to the decrease in the electrical angle, the rotational driving of the stepping motor 3 is controlled based on the b electrical angles corresponding to the b microsteps divided at the second interval within the range of a plurality of electrical angles equal to or smaller than a plurality of electrical angles corresponding to a plurality of one-phase excitation points (i.e., near a predetermined electrical angle after passing through a one-phase excitation point in the FWD direction). FIGS. 6A and 6B show detailed driving waveforms. This makes the moving amount of one microstep closer to the target value of −7.8125 μm, as shown in FIG. 6C.

As described above, the driving waveform is changed between when feeding the optical pickup head 4 in the forward direction and when feeding the optical pickup head 4 in the backward direction, thereby suppressing the unevenness of the moving amount of one microstep.

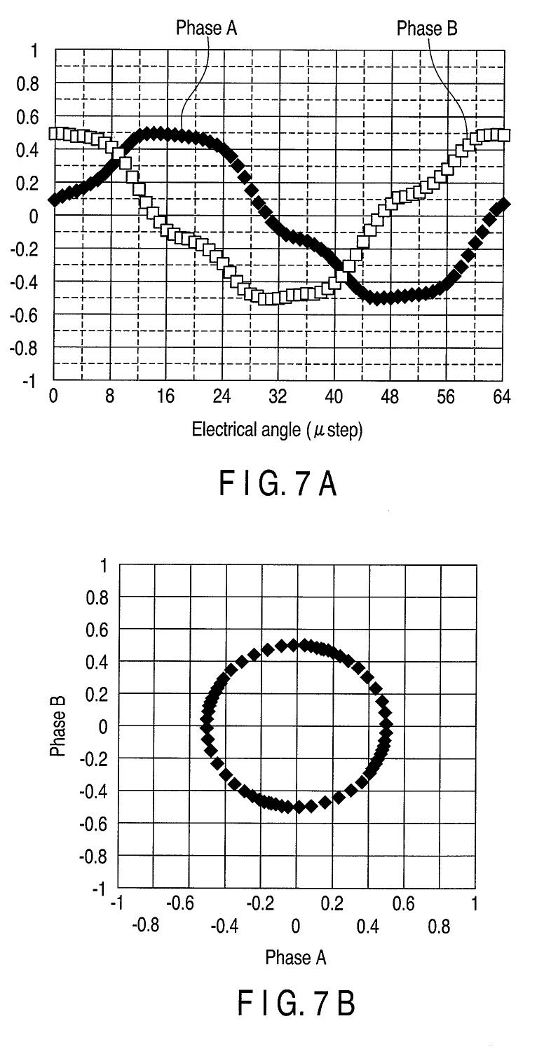

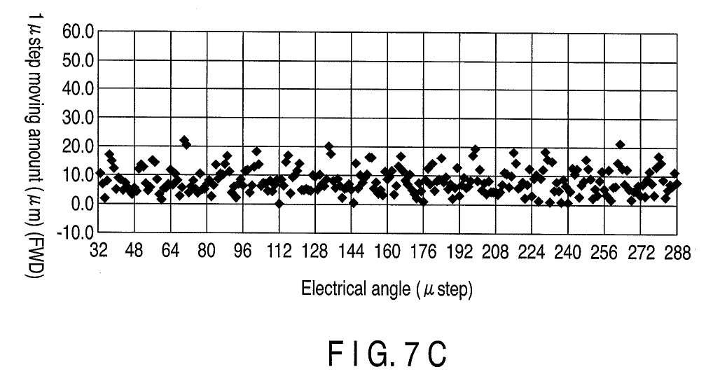

It is also possible to suppress the unevenness of the moving amount of one microstep by reducing the amplitude of the driving voltage, as shown in FIGS. 7A and 7B. This makes the moving amount of one microstep closer to the target value of 7.8125 μm, as shown in FIG. 7C. The unevenness of the torque of the motor is the large cause of the unevenness of the moving amount of one microstep. When the amplitude of the driving voltage is reduced, the level of the magnetic field excited in the motor lowers. This suppresses the unevenness of the torque. If the driving torque has a margin with respect to the frictional force, it is possible to suppress the unevenness of the moving amount of one microstep by lowering the driving voltage.

The functions and effects of this embodiment will be summarized below.

(1) It is possible to improve the optical pickup head feed pitch accuracy by shifting the electrical angle where stop/rotation of the stepping motor is repeated from a two-phase excitation point.

(2) The driving waveform of the stepping motor is changed from a general driving waveform (two-phase driving of sin, cos) to a driving waveform in which the microstep division is fine near an electrical angle at which the moving amount of one microstep is large, and coarse near an electrical angle at which the moving amount of one microstep is small. This allows to reduce the unevenness of the moving amount of one microstep.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical head moving control apparatus comprising:
a two-phase stepper motor configured to move an optical head in a first direction and in a second direction opposite to the first direction; and
a motor driver configured to stop and resume rotational driving of the stepper motor at a plurality of electrical angles different from a plurality of electrical angles corresponding to a plurality of two-phase excitation points when absolute values of driving voltages of two phases supplied to the stepper motor are substantially equal.

2. The apparatus of claim 1, wherein the motor driver is configured to stop and resume rotational driving of the stepper motor at a plurality of electrical angles larger than the plurality of electrical angles corresponding to the plurality of two-phase excitation points while moving the optical head in the first direction corresponding to an increase in the electrical angle, and to stop and resume rotational driving of the stepper motor at an electrical angle smaller than the plurality of electrical angles corresponding to the plurality of two-phase excitation points while moving the optical head in the second direction corresponding to a decrease in the electrical angle.

3. An optical head moving control apparatus comprising:
a two-phase stepper motor configured to move an optical head in a first direction and in a second direction opposite to the first direction; and
a motor driver configured to control rotational driving of the stepper motor based on an integer number, n, electrical angles corresponding to n microsteps obtained by dividing a section between two-phase excitation points,
wherein the motor driver is configured to control rotational driving of the stepping motor based on an integer number, a, electrical angles (n>a) corresponding to a microsteps divided at a first interval within a range of a plurality of electrical angles comprising a plurality of electrical angles corresponding to a plurality of two-phase excitation points when absolute values of driving voltages of two phases supplied to the stepping motor are substantially equal, and to control rotational driving of the stepping motor based on an integer number, b, electrical angles corresponding to b (n>b>a, n≧a+b) microsteps divided at a second interval smaller than the first interval within a range of a plurality of electrical angles comprising a plurality of electrical angles corresponding to a plurality of one-phase excitation points when one of the driving voltages of the two phases supplied to the stepping motor is zero.

4. The apparatus of claim 3, wherein the motor driver is configured to control rotational driving of the stepping motor based on the b electrical angles corresponding to the b microsteps divided at the second interval within a range of a plurality of electrical angles not smaller than the plurality of electrical angles corresponding to the plurality of one-phase excitation points while moving the optical head in the first direction corresponding to an increase in the electrical angle, and to control rotational driving of the stepping motor based on the b electrical angles corresponding to the b microsteps divided at the second interval within a range of a plurality of electrical angles not larger than the plurality of electrical angles corresponding to the plurality of one-phase excitation points while moving the optical head in the second direction corresponding to a decrease in the electrical angle.

5. An optical head moving control method by a two-phase stepper motor based on n electrical angles corresponding to an integer number, n, microsteps obtained by dividing a section between two-phase excitation points, comprising:
controlling rotational driving of the stepper motor based on an integer number, a, electrical angles corresponding to a (n>a) microsteps divided at a first interval within a range of a plurality of electrical angles comprising a plurality of electrical angles corresponding to a plurality of two-phase excitation points when absolute values of driving voltages of two phases supplied to the stepping motor are substantially equal, and
controlling rotational driving of the stepper motor based on an integer number, b, electrical angles corresponding to b (n>b>a, n≧a+b) microsteps divided at a second interval smaller than the first interval within a range of a plurality of electrical angles comprising a plurality of electrical angles corresponding to a plurality of one-phase excitation points when one of the driving voltages of the two phases supplied to the stepper motor is zero.

6. The method of claim 5, wherein
rotational driving of the stepper motor is controlled based on the b electrical angles corresponding to the b microsteps divided at the second interval within a range of a plurality of electrical angles equal to or larger than the plurality of electrical angles corresponding to the plurality of one-phase excitation points while moving an optical head in a first direction corresponding to an increase in the electrical angle, and
rotational driving of the stepper motor is controlled based on the b electrical angles corresponding to the b microsteps divided at the second interval within a range of a plurality of electrical angles equal to or smaller than the plurality of electrical angles corresponding to the plurality of one-phase excitation points while moving the optical head in a second direction corresponding to a decrease in the electrical angle.
